(19) United States
(12) Patent Application Publication
(10) Pub. No.: US 2005/0121107 A1
(43) Pub. Date: Jun. 9, 2005

(54) Blade and apparatus configured for forming tenons

(76) Inventor: Craig A. Lagerstrom, Leander, TX (US)

Correspondence Address: David O. Simmons, 7637 Parkview Cir., Austin, TX, 78731, US

(21) Appl. No.: 10/993,392

(22) Filed: Nov. 19, 2004

Related U.S. Application Data
(60) Provisional application No. 60/525,627, filed on Nov. 26, 2003.

(51) Int. Cl. B27C 1/00; B27C 5/00; B27G 13/00; B27M 1/00

(52) U.S. Cl. 144/218

(57) ABSTRACT

A circular saw apparatus configured for enabling one-pass forming of tenons using, for example, a commercially available table saw. The circular saw blade apparatus includes a pair of circular saw blades and a spacing device. Each one of the circular saw blades including a body having a first side, a second side, a cutting edge portion and spaced cutting tips attached to and projecting outwardly from the cutting edge portion of the body. The spacing device is disposed between and engaged with the body of each one of the circular saw blades. The blades and the spacing device are jointly configured for enabling a one-pass tenon forming operation to be performed. The one-pass tenon forming operation produces a tenon cheek depth of at least about three-sixteenth of an inch.

### CROSS REFERENCE TO RELATED APPLICATIONS

This application claims priority to co-pending U.S. Provisional Patent Application having Ser. No. 60/525,627 filed Nov. 26, 2003 entitled “Blade And Apparatus Configured For Forming Tenons”, having a common applicant herewith.

### FIELD OF THE DISCLOSURE

The disclosures herein relate generally to forming tenons for woodworking, and more particularly to blades and apparatuses configured for forming tenons.

### BACKGROUND OF THE DISCLOSURE

A mortise and tenon joint is a proven and widely used type of joint used in woodworking. It provides for exceptional strength in joining an end of one piece of wood to another piece of wood (or other suitable material). Furthermore, forming the mortise and the tenon is relatively simple, even for a small shop and hobbyist that is limited to making tenons using a table saw and mortises using a router.

To achieve visually appealing and strong mortise and tenon joints, it is important for each tenon of an item to have a snug fit with the respective mortise. It is equally important for the dimensions of each tenon and mortise to be formed repeatably. Without forming each mortise and tenon in an accurate and repeatable manner, the strength and appearance are often compromised.

For small shops and hobbyists, the ability of repeatably and accurately form tenons is generally the limiting factor with respect to strength and appearance of mortise and tenon joints. Equipment such as a router provides a means of accurately and repeatably forming mortises. However, the approaches for forming tenons that are known (i.e., conventional approaches) and used by such small shops and hobbyists are limited in their ability to accurately, repeatably and time-effectively form mortises.

One conventional approach for forming tenons requires four discrete cutting operations using a table saw. A table saw is fitted with a commercially available saw blade (e.g., a combination blade producing a ⅛″ wide kerf). Through use of a commercially available tenoning jig or a custom fabricated tenoning jig, two cuts separate cuts are made with a work-piece (e.g., a piece of wood) extending lengthwise upward from the surface of the table saw. These two cuts define the thickness of the tenon, the distance from the end of the work-piece to the face of the tenon's cheek and the side-to-side position of the tenon. Then, an additional cut is made on each side of the work-piece lengthwise along the base of each previous cut. These additional two cuts expose the full face of each cheek and expose the tenon itself. The four cuts required by this approach are time-consuming to make, and often lead to varying distances from the end of the work-piece to cheek, varying tenon thickness and varying side-to-side positioning of the tenon.

Another conventional approach for forming tenons requires three discrete cutting operations using a table saw. A table saw is fitted with a pair of commercially available saw blades (e.g., a pair of combination blades) that are spaced apart with a suitable spacer. The spacing between the teeth of the blades is set to achieve the desired tenon thickness. Through use of a commercially available tenoning jig or a custom fabricated tenoning jig, a work-piece is run through the spaced apart blades, thereby simultaneously making two spaced apart cuts that define the thickness of the tenon, the distance from the end of the work-piece to the face of the tenon's cheek and side-to-side positioning of the tenon. Then, an additional cut (e.g., using a single blade) is made on each side of the work-piece lengthwise along the base of each of the simultaneously made cuts. These additional two cuts expose the full face of each cheek and expose the tenon itself. The three cuts required by this approach are time-consuming to make, and often lead to varying distances from the end of the work-piece to cheek, varying tenon thickness and varying side-to-side positioning of the tenon. However, this approach does save a nominal amount of time over the four-cut approach discussed above and does serve to enhance dimensional accuracy and repeatability associated with the cuts that are made simultaneously.

In view of conventional approaches for making tenons using a commercially available table saw and circular saw blades, a method and equipment configured for forming a tenon in a manner that overcomes limitations associated with conventional methods and equipment for forming tenons would be advantageous and useful.

### BRIEF DESCRIPTION OF THE DRAWINGS

FIG. 1 depicts a side view of a table saw having a circular saw apparatus in accordance with an embodiment of the disclosures mounted thereon.

FIG. 2 depicts an end view of the table saw and circular saw apparatus depicted in FIG. 1.

FIG. 3 depicts a first embodiment of a circular saw blade as disclosed herein.

FIG. 4 depicts a second embodiment of a circular saw blade as disclosed herein.

### DETAILED DESCRIPTION OF THE DRAWINGS

Equipment and methods in accordance with embodiments of the disclosures made herein are configured for forming tenons in a manner that overcomes limitations associated with conventional methods and equipment for forming tenons. Specifically, such equipment and methods allow for a tenon to be made using a standard table saw in a manner that requires only one pass of a work-piece, reducing the number of required cuts by at least two relative to conventional approaches. A one-pass approach for forming tenons results in such tenons to be made in a manner that saves time, reduces variability in the distance from the end of the work-piece to the tenon cheek, reduces variability in tenon thickness and reduces variability in side-to-side positioning of the tenon. Accordingly, such equipment and methods provide for more visually appealing and consistently strong mortise and tenon joints to be made with respect to conventional approaches for forming tenons.

In one embodiment of the disclosures made herein, a circular saw blade configured for enabling one-pass forming of tenons includes a body and spaced cutting tips attached to the body. The body has a first side, a second side and a cutting edge portion. The spaced cutting tips are attached to and project outwardly from the cutting edge portion of the body. The cutting tips are configured for enabling a one-pass tenon forming operation to be performed. The one-pass tenon forming operation produces a tenon cheek depth of at least about three-sixteenth of an inch.

In another embodiment of the disclosures made herein, a circular saw blade configured for enabling one-pass forming of tenons includes a body and spaced cutting tips attached to the body. The body has a first side, a second side and a cutting edge portion. The spaced cutting tips are attached to and project outwardly from the cutting edge portion of the body. Each one of the cutting tips has a first side face disposed adjacent the first side of the body and a second side face disposed adjacent the second side of the body. A cutting edge of each of a first plurality of the cutting tips is tapered toward the first side of the body and a cutting edge of each of a second plurality of the cutting tips is tapered toward the second side of the body. The first side face of each one of the first plurality of cutting tips is laterally disposed by at least one-quarter inch from the second side face of each one of the second plurality of cutting tips.

In another embodiment of the disclosures made herein, a circular saw apparatus configured for enabling one-pass forming of tenons includes a pair of circular saw blades and a spacing device disposed between and engaged with a body of each one of the circular saw blades. Each one of the circular saw blades includes a body having a first side, a second side, a cutting edge portion and spaced cutting tips. The spaced cutting tips are attached to and project outwardly from the cutting edge portion of the body. The blades and the spacer are jointly configured for enabling a one-pass tenon forming operation to be performed. The one-pass tenon forming operation produces a tenon cheek depth of at least about three-sixteenth of an inch. Preferably, at least portions of the cutting tips of a first one of the blades are ground simultaneously with at least portions of the cutting tips of a second one of the blades thereby enabling cuts made by each one of the blades to be essentially identical.

In another embodiment of the disclosures made herein, a circular saw apparatus configured for enabling one-pass forming of tenons includes a pair of circular saw blades and a spacing device configured for being disposed between and engaged with a body of each one of the circular saw blades. Each one of the circular saw blades includes a body having a first side, a second side, a cutting edge portion and spaced cutting tips. The cutting tips are attached to and project outwardly from the cutting edge portion of the body. Each one of the cutting tips has a first side face disposed adjacent the first side of the respective attached body and a second side face disposed adjacent the second side of the respective attached body. The cutting edge of each of a first plurality of the cutting tips of each blade is tapered toward the first side of the body and a cutting edge of each of a second plurality of the cutting tips is tapered toward the second side of the body. The first side face of each one of the first plurality of cutting tips of each blade is laterally disposed by at least one-quarter inch from the second side face of each one of the second plurality of cutting tips.

The width of the cutting tips and the body thickness of circular saw blades as disclosed herein are novel and advantageous relative to conventional circular saw blades. A circular saw blade having cutting tips widths as disclosed herein (e.g., about three-sixteenths inch or wider) teaches away from conventional circular saw blade configurations. Conventional circular saw blades are seeking more narrow kerf widths, not wider.

Cutting tips as disclosed herein have a width (e.g., three-sixteenth inch, one-quarter inch or wider) that is specifically configured for one-pass forming of tenons having a cheek depth of about three-sixteenths inches or greater. For example, a circular saw blade that has cutting tips that are one-quarter inch wide allows for one-pass forming of tenons having a cheek depth of nominally one-quarter inch. To produce a comparable tenon using a conventional commercially available circular saw blade would require a minimum of three passes of the workpiece and often results in tenon-to-tenon variability even during the same set-up.

Similarly, a circular saw blade body having a thickness as disclosed herein (e.g., three-thirty-seconds of an inch or wider) is specifically suited for forming tenons in a one-pass manner. A relatively thick body provides for increased rigidity (e.g., resistance to bending and twisting) and greater cutting tip bond area (e.g., weld interface). Such increased rigidity contributes to greater accuracy in tenons, less heating of the blade and longer blade life.

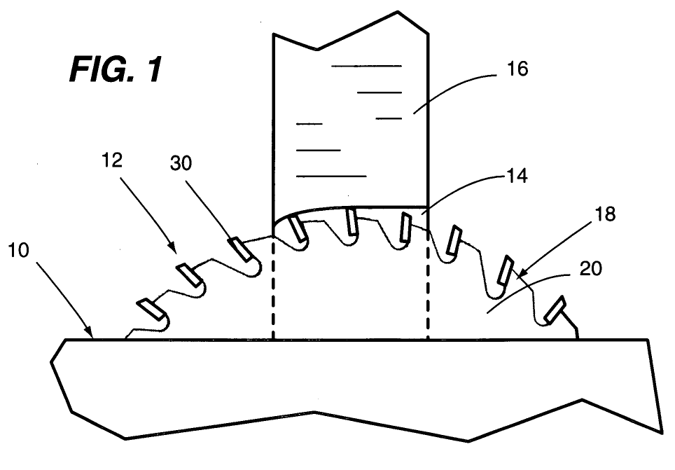

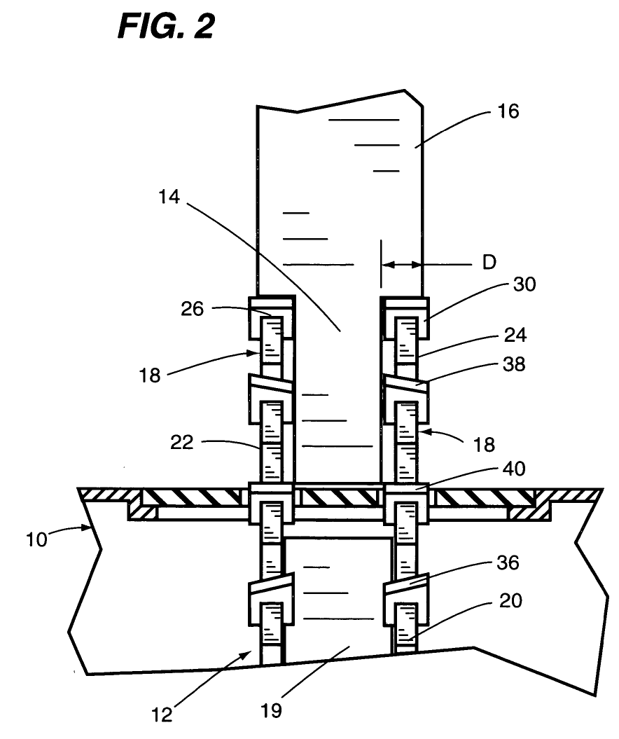

Referring now to specific drawings, FIGS. 1 and 2 depicts a table saw 10 having a circular saw apparatus 12 in accordance with an embodiment of the disclosures mounted thereon (i.e., on an arbor of a table saw motor). The circular saw apparatus 12 is configured for enabling one-pass forming of tenons (e.g., a tenon 14 at the end of a work-piece 16). The circular saw apparatus 12 includes a pair of circular saw blades 18 and a spacing device 19. The blades 18 and the spacing device 19 are jointly configured for enabling a one-pass tenon forming operation to be performed. The one-pass tenon forming operation produces a tenon cheek depth D, which is a full cheek depth as opposed to that made using a conventional blade being a partial depth requiring additional cuts to produce the full depth.

Each one of the circular saw blades 18 includes a body 20 having a first side 22, a second side 24, a cutting edge portion 26 and spaced cutting tips 30 attached to and projecting outwardly from the cutting edge portion 26 of the body 20. In one embodiment, the body 20 is formed from steel plate (e.g., blanked, laser cut, wire cut water cut, etc) and the cutting tips 30 are carbide inserts welded to the body 20. The spacing device 19 is disposed between and engaged with the body 20 of each one of the circular saw blades 18. Preferably, the body 20 of each circular saw blade 18 and the spacing device 19 each include a centrally located arbor passage (not specifically shown) configured for receiving a standard table saw motor arbor, thereby allowing the circular saw apparatus 12 to be mounted on the table saw 10.

Examples of the spacing device include a spacer machined from aluminum or molded from a polymeric material. It is contemplated herein that the blades 18 may each be fixedly attached by securing means (e.g., using screws, rivets hat staking) to the spacing device 19 or held in contact with the spacing device 19 via a nut on an arbor of a table saw motor. In such embodiment, it is contemplated that the blades 18 are precision aligned (e.g., at an arbor hole), whereby each blade is essentially concentric with the other blade.

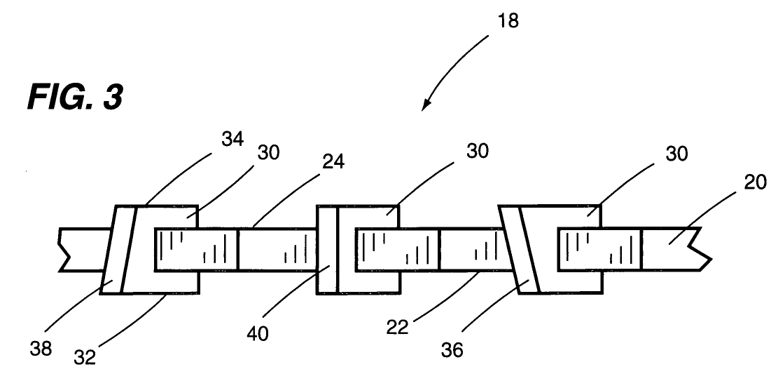

Referring now to FIGS. 1-3, each one of the cutting tips 30 have a first side face 32 disposed adjacent the first side 22 of the body 20 and a second side face 34 disposed adjacent the second side 24 of the body 20. A first plurality of the cutting tips 30 have tapered cutting edges 36 that are tapered toward the first side 22 of the body 20. A second plurality of the cutting tips 30 have tapered cutting edges 38 that are tapered toward the second side 24 of the body 20. A third plurality of the cutting tips 30 have tapered cutting edges 40 that are essentially level with respect to the first side 22 and second side 24 of the body 20.

The first side face 32 of each one of the first plurality of cutting tips 30 is laterally disposed by preferably at least one-quarter inch, and as little as three-sixteenths of and inch, from the second side face 34 of each one of the second plurality of cutting tips 30. Preferably, each one of the third plurality of the cutting tips 30 has a maximum width approximately equal to the lateral distance between the first side face 32 of the first plurality of cutting tips 30 and second side face 34 of the second plurality of cutting tips 30. Accordingly, in this embodiment, all of the cutting tips 30 are approximately the same width.

Preferably, the body 20 of each one of the circular saw blades 18 is generally flat and has a thickness of at least three-thirty seconds of an inch. Suitable pairing of cutting tip width and body thickness have been found to be a one-quarter inch cutting tip width with a three-thirty seconds inch body thickness, and a five-sixteenth inch cutting tip width with one-eighth inch body thickness. In view of the disclosures made herein, other suitable pairings of cutting tip width and body thickness will become apparent.

Preferably, at least portions of the cutting tips of one of the pair of blades 18 are ground during their manufacture in a simultaneous manner with at least portions of the cutting tips of the other one of the blades 18. In this manner, cuts made by each one of the blades 18 are essentially identical. In one embodiment such simultaneous grinding of the cutting tips includes mounting a pair of template blades (e.g., bodies with unground cutting tips welded thereto) on an arbor of a blade-grinding machine with a suitable spacer (e.g., having a thickness slightly greater than the width of the cutting tips) positioned between the pair of blades 18. Then, the surfaces corresponding to the cutting edge of each cutting tip and/or to the overall diameter of the blade are ground simultaneously to produce a matched pair of blades.

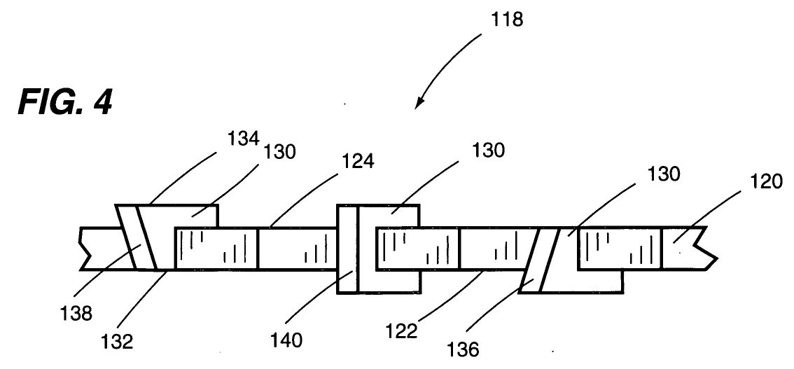

FIG. 4 depicts an alternate embodiment of a circular saw blade 118 compatible for enabling one-pass forming of tenons in accordance with the disclosures made herein. The circular saw blade 118 includes a body 120 having a first side 122, a second side 124, a cutting edge portion 126 and spaced cutting tips 130. The cutting tips 130 are attached to and project outwardly from the cutting edge portion 126 of the body 120. Each one of the cutting tips 130 has a first side face 132 disposed adjacent the first side 122 of the body 120 and a second side face 134 disposed adjacent the second side 124 of the body 120.

A first plurality of the cutting tips 130 have tapered cutting edges 136 that are tapered toward the first side 122 of the body 120. A second plurality of the cutting tips 130 have tapered cutting edges 138 that are tapered toward the second side 124 of the body 120. A third plurality of the cutting tips 130 have tapered cutting edges 140 that are essentially level with respect to the first side 122 and second side 124 of the body 120.

The first side face 132 of each one of the cutting tips 130 of the first plurality of cutting tips 130 (i.e., the cutting tips 130 having cutting edges 136 that are tapered toward the first side 122 of the body 120) is offset toward the first side 122 of the body 120. The second side face 134 of each one of the cutting tips 130 of the second plurality of cutting tips 130 (i.e., the cutting tips 130 having cutting edges 138 that are tapered toward the second side 124 of the body 120) is offset toward the second side 124 of the body 120.

The first side face 132 of each one of the first plurality of cutting tips 130 is laterally disposed by preferably at least one-quarter inch, and as little as three-sixteenths of and inch, from the second side face 134 of each one of the second plurality of cutting tips 130. Preferably, each one of the third plurality of the cutting tips 130 has a maximum width approximately equal to the lateral distance between the first side face 132 of the first plurality of cutting tips 130 and second side face 134 of the second plurality of cutting tips 130. Accordingly, in this embodiment, all of the cutting tips 130 are approximately the same width. Preferably, the body 120 is generally flat and has a thickness of at least three-thirty seconds of an inch.

It is contemplated herein that circular saw blades in accordance with embodiments of the disclosures made herein may have any one of a variety of different overall diameters. Such overall diameters may be at least partially dependent upon the width of the cutting tips and the resulting force created at the cutting tips during a tenon forming operation. For example, a blade with five-sixteenth inch cutting tips may preferably have an eight-inch diameter rather than a ten-inch diameter to reduce bending and twisting of the blade body. Tenon length is another factor upon which blade diameter is based. For example, an eight-inch blade can readily produce a tenon having a length of about one and one-half inches.

Preferably, the cutting tips of circular saw blades disclosed herein will be configured for minimizing, if not eliminating, rip out of material of a work piece. A person of ordinary skill in the art of making circular saw blades (i.e., an engineer employed by a blade manufacturing company to design blades) will have the knowledge of cutting edge profiles that will minimize, if not eliminate, rip out of material.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A circular saw blade configured for enabling one-pass forming of tenons, comprising:
a body having a first side, a second side and a cutting edge portion; and
spaced cutting tips attached to and projecting outwardly from the cutting edge portion of the body;
wherein each one of said cutting tips has a first side face disposed adjacent the first side of the body and a second side face disposed adjacent the second side of the body;
wherein a cutting edge of each of a first plurality of said cutting tips is tapered toward the first side of the body and a cutting edge of each of a second plurality of said cutting tips is tapered toward the second side of the body; and
wherein the first side face of each one of the first plurality of cutting tips is laterally disposed by at least one-quarter inch from the second side face of each one of the second plurality of cutting tips.

2. The circular saw blade of claim 1 wherein the body is generally flat and has a thickness of at least three-thirty seconds of an inch.

3. The circular saw blade of claim 2 wherein the body includes a centrally located arbor passage configured for receiving standard table saw motor arbors, whereby the body is mountable on a standard table saw.

4. The circular saw blade of claim 1 wherein:
the first side face of each one of the first plurality of cutting tips is offset toward the first side of the body with respect to the first side face of each one of the second plurality of cutting tips; and
the second side face of each one of the second plurality of cutting tips is offset toward the second side of the body with respect to the second side face of each one of the first plurality of cutting tips.

5. The circular saw blade of claim 4 wherein
a third plurality of said cutting tips each have a cutting edge that is essentially level with respect to the first side and second side of the body; and
each one of the third plurality of said cutting tips has a maximum width approximately equal to a lateral distance between the first side face of the first plurality of cutting tips and second side face of the second plurality of cutting tips.

6. The circular saw blade of claim 5 wherein the body is generally flat and has a thickness of at least three-thirty seconds of an inch.

7. The circular saw blade of claim 1 wherein
a third plurality of said cutting tips each have a cutting edge that is essentially level with respect to the first side and second side of the body; and
all of said cutting tips have a maximum width approximately equal to a lateral distance between the first side face of the first plurality of cutting tips and second side face of the second plurality of cutting tips.

8. The circular saw blade of claim 7 wherein the body is generally flat and has a thickness of at least three-thirty seconds of an inch.

9. A circular saw blade configured for enabling one-pass forming of tenons, comprising:
a body having a first side, a second side and a cutting edge portion; and
spaced cutting tips attached to and projecting outwardly from the cutting edge portion of the body, wherein said cutting tips are configured for enabling a one-pass tenon forming operation to be performed and wherein the one-pass tenon forming operation produces a tenon cheek depth of at least about three-sixteenth of an inch.

10. The circular saw blade of claim 9 wherein the body is generally flat and has a thickness of at least three-thirty seconds of an inch.

11. The circular saw blade of claim 9 wherein said cutting tips being configured for enabling a one-pass tenon forming operation to be performed includes:
each one of said cutting tips having a first side face disposed adjacent the first side of the body and a second side face disposed adjacent the second side of the body;
a cutting edge of a first plurality of said cutting tips is tapered toward the first side of the body;
a cutting edge of a second plurality of said cutting tips is tapered toward the second side of the body; and
the first side face of each one of the first plurality of cutting tips is laterally disposed by at least one-quarter inch from the second side face of each one of the second plurality of cutting tips.

12. The circular saw blade of claim 11 wherein the body is generally flat and has a thickness of at least three-thirty seconds of an inch.

13. The circular saw blade of claim 12 wherein the body includes a centrally located arbor passage configured for receiving standard table saw motor arbors, whereby the body is mountable on a standard table saw.

14. The circular saw blade of claim 11 wherein:
the first side face of each one of the first plurality of cutting tips is offset toward the first side of the body with respect to the first side face of each one of the second plurality of cutting tips; and
the second side face of each one of the second plurality of cutting tips is offset toward the second side of the body with respect to the second side face of each one of the first plurality of cutting tips.

15. The circular saw blade of claim 14 wherein
a third plurality of said cutting tips each have a cutting edge that is essentially level with respect to the first side and second side of the body; and
each one of the third plurality of said cutting tips has a maximum width approximately equal to a lateral distance between the first side face of the first plurality of cutting tips and second side face of the second plurality of cutting tips.

16. The circular saw blade of claim 15 wherein the body is generally flat and has a thickness of at least three-thirty seconds of an inch.

17. The circular saw blade of claim 11 wherein
a third plurality of said cutting tips each have a cutting edge that is essentially level with respect to the first side and second side of the body; and
all of said cutting tips have a maximum width approximately equal to a lateral distance between the first side face of the first plurality of cutting tips and second side face of the second plurality of cutting tips.

18. The circular saw blade of claim 17 wherein the body is generally flat and has a thickness of at least three-thirty seconds of an inch.

19. A circular saw apparatus configured for enabling one-pass forming of tenons, comprising:
a pair of circular saw blades, each one of said circular saw blades including a body having a first side, a second side, a cutting edge portion and spaced cutting tips attached to and projecting outwardly from the cutting edge portion of the body; and
a spacing device configured for being disposed between and engaged with the body of each one of said circular saw blades;
wherein said blades and said spacing device are jointly configured for enabling a one-pass tenon forming operation to be performed and wherein the one-pass tenon forming operation produces a tenon cheek depth of at least about three-sixteenth of an inch.

20. The circular saw apparatus of claim 19 wherein each one of said blades is fixedly attached to the spacing device.

21. The circular saw apparatus of claim 19 wherein at least portions of said cutting tips of a first one of said blades is ground simultaneously with at least portions of said cutting tips of a second one of said blades thereby enabling cuts made by each one of said blades to be essentially identical.

22. The circular saw blade of claim 19 wherein said cutting tips being configured for enabling a one-pass tenon forming operation to be performed includes:
each one of said cutting tips having a first side face disposed adjacent the first side of the body and a second side face disposed adjacent the second side of the body;
a cutting edge of a first plurality of said cutting tips is tapered toward the first side of the body;
a cutting edge of a second plurality of said cutting tips is tapered toward the second side of the body; and
the first side face of each one of the first plurality of cutting tips is laterally disposed by at least one-quarter inch from the second side face of each one of the second plurality of cutting tips.

23. The circular saw blade of claim 22 wherein the body is generally flat and has a thickness of at least three-thirty seconds of an inch.

24. The circular saw blade of claim 23 wherein the body includes a centrally located arbor passage configured for receiving standard table saw motor arbors, whereby the body is mountable on a standard table saw.

25. The circular saw blade of claim 22 wherein:
the first side face of each one of the first plurality of cutting tips is offset toward the first side of the body with respect to the first side face of each one of the second plurality of cutting tips; and
the second side face of each one of the second plurality of cutting tips is offset toward the second side of the body with respect to the second side face of each one of the first plurality of cutting tips.

26. The circular saw blade of claim 25 wherein
a third plurality of said cutting tips each have a cutting edge that is essentially level with respect to the first side and second side of the body; and
each one of the third plurality of said cutting tips has a maximum width approximately equal to a lateral distance between the first side face of the first plurality of cutting tips and second side face of the second plurality of cutting tips.

27. The circular saw blade of claim 26 wherein the body is generally flat and has a thickness of at least three-thirty seconds of an inch.

28. The circular saw blade of claim 22 wherein
a third plurality of said cutting tips each have a cutting edge that is essentially level with respect to the first side and second side of the body; and
all of said cutting tips have a maximum width approximately equal to a lateral distance between the first side face of the first plurality of cutting tips and second side face of the second plurality of cutting tips.

29. The circular saw blade of claim 28 wherein the body is generally flat and has a thickness of at least three-thirty seconds of an inch.

30. A circular saw apparatus configured for enabling one-pass forming of tenons, comprising:
a pair of circular saw blades, each one of said circular saw blades including a body having a first side, a second side, a cutting edge portion and spaced cutting tips attached to and projecting outwardly from the cutting edge portion of the body, wherein at least portions of said cutting tips of a first one of said blades is ground simultaneously with at least portions of said cutting tips of a second one of said blades thereby enabling cuts made by each one of said blades to be essentially identical; and
a spacing device disposed between and engaged with the body of each one of said circular saw blades;
wherein said blades and the spacing device are jointly configured for enabling a one-pass tenon forming operation to be performed and wherein the one-pass tenon forming operation produces a tenon cheek depth of at least about three-sixteenth of an inch.

31. The circular saw apparatus of claim 30 wherein:
each one of said cutting tips has a first side face disposed adjacent the first side of the respective attached body and a second side face disposed adjacent the second side of the respective attached body;
a cutting edge of each of a first plurality of said cutting tips is tapered toward the first side of the respective attached body;
a cutting edge of each of a second plurality of said cutting tips is tapered toward the second side of the respective attached body;
a cutting edge of each of a third plurality of said cutting tips is essentially level with respect to the first side and second side of the body;
the first side face of each one of the first plurality of cutting tips is laterally disposed by at least one-quarter inch from the second side face of each one of the second plurality of cutting tips; and
each one of the third plurality of said cutting tips has a maximum width approximately equal to a lateral distance between the first side face of the first plurality of cutting tips and second side face of the second plurality of cutting tips.

32. The circular saw apparatus of claim 31 wherein the body has a thickness of at least one-eighth inch.

33. The circular saw apparatus of claim 32 wherein the body includes a centrally located arbor passage configured for receiving standard table saw motor arbors, whereby the body is mountable on a standard table saw.

34. A circular saw apparatus configured for enabling one-pass forming of tenons, comprising:
a pair of circular saw blades, each one of said circular saw blades including a body having a first side, a second side, a cutting edge portion and spaced cutting tips attached to and projecting outwardly from the cutting edge portion of the body; and
a spacing device configured for being disposed between and engaged with the body of each one of said circular saw blades;
wherein each one of said cutting tips has a first side face disposed adjacent the first side of the respective attached body and a second side face disposed adjacent the second side of the respective attached body;
wherein a cutting edge of each of a first plurality of said cutting tips of each blade is tapered toward the first side of the body and a cutting edge of each of a second plurality of said cutting tips is tapered toward the second side of the body; and
wherein the first side face of each one of the first plurality of cutting tips of each blade is laterally disposed by at least one-quarter inch from the second side face of each one of the second plurality of cutting tips.

35. The circular saw apparatus of claim 34 wherein at least portions of said cutting tips of a first one of said blades is ground simultaneously with at least portions of said cutting tips of a second one of said blades thereby enabling cuts made by each one of said blades to be essentially identical.

36. The circular saw apparatus of claim 34 wherein:
the first side face of each one of the first plurality of cutting tips is offset toward the first side of the body with respect to the first side face of each one of the second plurality of cutting tips; and
the second side face of each one of the second plurality of cutting tips is offset toward the second side of the body with respect to the second side face of each one of the first plurality of cutting tips.

37. The circular saw blade of claim 36 wherein
a third plurality of said cutting tips each have a cutting edge that is essentially level with respect to the first side and second side of the body; and
each one of the third plurality of said cutting tips has a maximum width approximately equal to a lateral distance between the first side face of the first plurality of cutting tips and second side face of the second plurality of cutting tips.

38. The circular saw blade of claim 37 wherein the body is generally flat and has a thickness of at least three-thirty seconds of an inch.

39. The circular saw blade of claim 34 wherein
a third plurality of said cutting tips each have a cutting edge that is essentially level with respect to the first side and second side of the body; and
all of said cutting tips have a maximum width approximately equal to a lateral distance between the first side face of the first plurality of cutting tips and second side face of the second plurality of cutting tips.

40. The circular saw blade of claim 39 wherein the body is generally flat and has a thickness of at least three-thirty seconds of an inch.
